(19) United States
(12) Patent Application Publication
(10) Pub. No.: US 2020/0081688 A1
(43) Pub. Date: Mar. 12, 2020

(54) SPECULATIVE CALCULATIONS IN SQUARE ROOT OPERATIONS

(71) Applicant: Arm Limited, Cambridge, MA (US)

(72) Inventor: Javier Diaz BRUGUERA, Austin, TX (US)

(21) Appl. No.: 16/123,236

(22) Filed: Sep. 6, 2018

(51) Int. Cl. G06F 7/552; G06F 7/499; G06F 7/49

(52) U.S. Cl. CPC G06F 7/5525; G06F 7/49; G06F 7/49936

(57) ABSTRACT

A data processing apparatus is provided that includes input circuitry to receive a signal corresponding to a square root instruction that identifies an input value. Processing circuitry performs an iterative square root operation on the input value and includes digit determination circuitry to determine, for a current iteration, a next digit of an least partial result of the square root operation and remainder determination circuitry that determines, for the current iteration, an at least partial remainder of the square root operation. The next digit for the current iteration is determined based on an least partial remainder of the square root operation from a previous iteration. The at least partial remainder for the current iteration is determined based on the at least partial remainder and the at least partial result of the square root operation from the previous iteration and the processing circuitry is adapted to speculatively generate a set of candidate at least partial remainders of the square root operation for the current iteration prior to the at least partial result of the square root operation for the current iteration being determined.

### TECHNICAL FIELD

The present disclosure relates to data processing. More particularly, it relates to the calculation of square roots.

### DESCRIPTION

Square roots can be calculated using iterative digit recurrence. At each iteration (other than a first) results from the previous iteration are input and one or more digits of the result are output. It is desirable for the circuitry that performs each iteration to operate quickly so that a larger number of digits can be output during a single cycle of the processor clock. The result is a faster circuit that can calculate square roots more quickly.

### SUMMARY

Viewed from a first example configuration, there is provided a data processing apparatus comprising: input circuitry to receive a signal corresponding to a square root instruction that identifies an input value; processing circuitry to perform an iterative square root operation on the input value, the processing circuitry comprising: digit determination circuitry to determine, for a current iteration, a next digit of an least partial result of the square root operation; and remainder determination circuitry to determine, for the current iteration, an at least partial remainder of the square root operation, wherein the next digit for the current iteration is determined based on an least partial remainder of the square root operation from a previous iteration; the at least partial remainder for the current iteration is determined based on the at least partial remainder and the at least partial result of the square root operation from the previous iteration; and the processing circuitry is adapted to speculatively generate a set of candidate at least partial remainders of the square root operation for the current iteration prior to the at least partial result of the square root operation for the current iteration being determined.

Viewed from a second example configuration, there is provided a data processing method comprising: receiving a signal corresponding to a square root instruction that identifies an input value; performing an iterative square root operation on the input value by: determining, for a current iteration, a next digit of an least partial result of the square root operation; determining, for the current iteration, an at least partial remainder of the square root operation, wherein the next digit for the current iteration is determined based on an least partial remainder of the square root operation from a previous iteration; the at least partial remainder for the current iteration is determined based on the at least partial remainder and the at least partial result of the square root operation from the previous iteration; and a set of candidate at least partial remainders of the square root operation are speculatively generated for the current iteration prior to the next digit being determined.

Viewed from a third example configuration, there is provided a data processing apparatus comprising: means for receiving a signal corresponding to a square root instruction that identifies an input value; means for performing an iterative square root operation on the input value comprising: means for determining, for a current iteration, a next digit of an least partial result of the square root operation; and means for determining, for the current iteration, an at least partial remainder of the square root operation, wherein the next digit for the current iteration is determined based on an least partial remainder of the square root operation from a previous iteration; the at least partial remainder for the current iteration is determined based on the at least partial remainder and the at least partial result of the square root operation from the previous iteration; and means for speculatively generating a set of candidate at least partial remainders of the square root operation for the current iteration prior to the next digit being determined.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus in accordance with some embodiments;

FIG. 2 illustrates an example of the processing circuitry in accordance with some embodiments; FIGS. 3 and 4 illustrate the relocation of circuitry in the processing circuitry in accordance with some embodiments;

FIG. 5 illustrates an example of the processing circuitry in accordance with some embodiments; and

FIG. 6 illustrates a flowchart that shows a method of data processing in accordance with some embodiments.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: input circuitry to receive a signal corresponding to a square root instruction that identifies an input value; processing circuitry to perform an iterative square root operation on the input value, the processing circuitry comprising:

digit determination circuitry to determine, for a current iteration, a next digit of an least partial result of the square root operation; and remainder determination circuitry to determine, for the current iteration, an at least partial remainder of the square root operation, wherein the next digit for the current iteration is determined based on an least partial remainder of the square root operation from a previous iteration; the at least partial remainder for the current iteration is determined based on the at least partial remainder and the at least partial result of the square root operation from the previous iteration; and the processing circuitry is adapted to speculatively generate a set of candidate at least partial remainders of the square root operation for the current iteration prior to the at least partial result of the square root operation for the current iteration being determined.

By speculatively generating a set of candidate at least partial remainders of the square root operation, it is possible to remove the generation of the at least partial remainders from the critical path of the operation performed by the data processing apparatus. This can be achieved, for instance, by generating the set of candidate at least partial remainders at the same time as other operations are being performed. Once the next digit of the operation has been determined, this can be used to select one of the candidates in order to output the resultant at least partial remainder of the square root operation for the current iteration. Thus, the time taken to perform one of the iterations is reduced. This can reduce timing constraints on the circuitry and may, in certain circumstances, make it possible for the number of iterations performed in a clock cycle to be increased over a system where the generation of the at least partial remainder is not speculatively determined. Note that although the term “square root” is used herein, it could be the case that an exact square root cannot be determined (e.g. due to the number being irrational, or incapable of representation in binary) as would be known in the art. Thus, the term “square root” is intended to cover approximations of square roots that occur in such circumstances.

In some embodiments, each of the candidate at least partial remainders of the square root operation for the current iteration is in redundant representation. Redundant representation is a technique that enables data values to be efficiently passed between certain circuits. In particular, redundant representation represents a number as a pair of values rather than a single value. The pair could be sum and carry values or could be positive and negative values. Certain circuits, such as addition circuits, are able to process numbers given in this format more quickly than if they are given in another format. By speculatively producing candidate values of the at least partial remainders of the square root operation in redundant representation, time that might have been spent converting the candidate into non-redundant representation can be removed from the critical path.

In some embodiments, the processing circuitry is adapted to speculatively generate the set of candidate at least partial remainders of the square root operation for the current iteration prior to the next digit being determined by the digit determination circuitry. The at least partial result of the square root operation for the current iteration comprises the at least partial result of the square root operation for a previous iteration and the next digit that has been calculated in respect of the current iteration. In this manner, each iteration adds further digits to the at least partial result.

In some embodiments, the set of candidate at least partial remainders comprises one candidate value for each possible value of a most recent digit of the at least partial remainder. At each iteration, a further digit of the at least partial result of the square root operation is output. However, there are only a finite number of possibilities for the digit that is output. The number of possible digits is dependent on the radix (r) of the square-root operation. Typically, digits may take the values: {−a, −(a−1), . . . −1, 0, +1, , +a} where a≥ceil(r/2) and a<r. For radix 4, if a=2, then this gives the set {−2, −1, 0, 1, 2}. This is referred to as a minimally redundant digit set. If a=3 then there would be seven values {−3, −2, −1, 0, 1, 2, 3}. This is referred to as a maximally redundant digit set. If a=4, then there would be nine values {−4, −3, −2, −1, 0, 1, 2, 3, 4}. This is referred to as an over-redundant digits set, since a>r−1. Accordingly, the data processing apparatus speculatively produces a candidate set of at least partial remainders by producing one candidate for each possible value of the digits. By using the minimally redundant set, the number of candidates is kept low and thus the amount of circuity necessary to consider each candidate is also kept low. In the above example, one candidate will correspond with the possible digit −2, another candidate will correspond with the possible digit −1, etc. Having calculated the partial remainders given all of these possibilities, once the next digit is known, it is possible to determine which of these possible digits is correct and the corresponding at least partial remainder can then be selected from the candidates. This removes the need to calculate the at least partial remainder only after the next digit is known and thus removes this calculation from the critical path.

In some embodiments, the data processing apparatus comprises normalisation circuitry to normalise the input value. In normalised form, the mantissa is greater than or equal to 1 and less than 2. However, the integer portion of the mantissa is not stored in a floating point number. Also, in some embodiments, scaling is performed (e.g. by scaling circuitry). This allows certain assumptions to be made about the input value, and hence the output value. For instance, the scaling might involve altering the mantissa (e.g. dividing it by two) and thereby adjusting the exponent. If the exponent can be made to be even, then the square root's exponent can be determined by dividing the exponent of the input value by two.

In some embodiments, the processing circuitry is adapted to perform two iterations in a single clock cycle. By reducing the timing necessary in order to perform each of the iterations, it may be possible to increase the number of iterations of the square root operation that are possible per clock cycle. In this way, the present technique may be applied to a circuitry that achieves at least two iterations per clock cycle. Accordingly, the overall square root operation may be performed more quickly (e.g. using fewer clock cycles) than other proposed techniques.

In some embodiments, the iterative square root operation is radix-4. A radix-4 implementation of the present embodiment makes it possible to output digits in the format of two binary numbers at each iteration. For instance, if the digit set includes {−2, −1, 0, +1, +2} then these could be encoded in binary as part of a redundant representation as: −2=>10, −1=>01, 0=>00, +1=>01, +2=>10. Note that the same outputs are provided for the positive and negative values (e.g. both −2 and +2 output the binary value 10). This is because in redundant representation, the negative values and positive values are provided as separate words. For example, the sequence 1, −2, 0 would be encoded as a positive word of 01, 00, 00 and a negative word of 00, 10, 00. In other embodiments, other radices are possible such as 2 or 8. However, since there are more possible output digits, the number of candidate at least partial remainders will also increase. Therefore increasing the radix (and consequently decreasing the number of iterations required to determine the square root) occurs more extensive circuitry.

In some embodiments, the at least partial remainder of the square root operation from the previous iteration comprises a predetermined number of most significant bits of an at least partial remainder of the square root operation from the previous iteration. Rather than consider all of the bits of at least partial remainder of the square root operation from the previous iteration, only a predetermined number of most significant bits of the at least partial remainder of the square root operation from the previous iteration are considered. This predetermined number is dependent on the radix of the square root operation and comprises a sufficient number of bits such that it is necessary for rounding operations are included. In this way, insignificant bits that would have no effect on the overall output of the result can be discarded leading to a less complex circuit.

In some embodiments, at least one of the at least partial remainder of the square root operation from the previous iteration and the at least partial result of the square root operation from the previous iteration is provided in redundant representation.

In some embodiments, the processing circuitry is adapted to speculatively generate the set of candidate at least partial remainders of the square root operation for the current iteration in both redundant and non-redundant representation; and the candidate at least partial remainders of the square root operation for the current iteration that are in non-redundant representation are based on most significant bits of the at least partial remainder of the square root operation from the previous iteration. For instance, this could be achieved by generating the set of candidate at least partial remainders of the square root operation for the current iteration in redundant representation and then taking most significant bits of those candidates and converting them into redundant representation. By generating the set of candidate at least partial remainders of the square root operation from the current iteration in redundant representation, the selected candidate can be provided as an input to a next iteration. By providing the candidate set of approximate remainders in non-redundant representation, it is possible to use the selected candidate as part of the comparison function used in order to select a next digit of the next iteration. In this way, two elements of the square root operation can be removed from the critical path thereby other reducing the timing constraints of the circuitry.

Particular embodiments will now be described with reference to the figures.

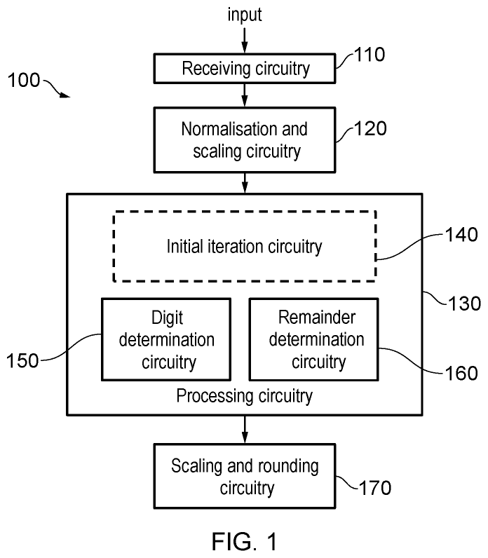

FIG. 1 shows an apparatus 100 in accordance with some embodiments. The apparatus 100 includes receiving circuitry 110 that is responsible for receiving an input value. The input value may be received as part of a signal corresponding to a square root instruction. The signal has the effect of causing the apparatus 100 to perform a square root operation on the input value in order to output a value corresponding with the square root of the input value. Note that the actual square root of the input value may be, for instance, an irrational number or another type of number that cannot be accurately represented in binary representation. Accordingly, the output could actually be an approximation of the square root of the input value.

Having received the input value, the receiving circuitry 110 provides the input value to normalisation and scaling circuitry 120. In some embodiments, the normalisation and scaling circuitry performs initial normalisation and scaling operations on the input value. These operations can be performed in order to improve the degree to which the floating point operation can be performed. For instance, by performing particular operations such that the input value is received in a particular format, it may be possible to make assumptions regarding how the square root operation is to proceed. As a consequence, further iterations of the square root operation may be simplified thereby using less circuitry or thereby performing the square root operation in a smaller number of processing cycles that would otherwise be required. In some embodiments, the normalisation process makes it possible for initial iterations of the square root operation to proceed more quickly.

Having performed any necessary normalisation and scaling, the input value is passed to processing circuitry 130. The processing circuitry 130 comprises initial iteration circuitry 140 together with digit determination circuitry 150 and remainder determination circuitry 160. In this embodiment, the initial iteration circuitry 140 performs an initial iteration of an iterative square root operation. In some embodiments, the role of the initial iteration circuitry 140 is not an explicit, separate element but is instead performed by the digit determination circuitry 150 and the remainder determination circuitry 160. In other embodiments, the initial iteration circuitry is a simplified version of the digit determination circuitry 150 and the remainder determination circuitry 160. In particular, if it is known that the input into the initial iteration circuitry 140 has a particular format, then the initial iteration of the square root operation could be simplified. For instance, if it is known that the input value is between two boundaries (e.g. as achieved by the normalisation and scaling circuitry) then it might also be known that the output value will be between two boundaries, therefore limiting the possible digits that are output in a first iteration. Such techniques are beyond the scope of the present disclosure, except to the extent that the present disclosure does not preclude such techniques being used.

Having performed the initial iteration, the digit determination circuitry 150 and the remainder determination circuitry 160 perform further iterations of the square root operation. At each iteration, one or more further digits of the final result are produced by the digit determination circuitry 150. When a desired level of accuracy is reached (e.g. when a desired number of digits have been output by the digit determination circuitry 150) the iterative operation performed by the processing circuitry 130 ends and the set of digits output by the digit determination circuitry 150 are concatenated. The concatenated result is then passed to scaling and rounding circuitry 170 where scaling operations and rounding operations may be performed as necessary. Note that the scaling operation performed by the scaling and rounding circuitry 170 may correspond to the inverse of any scaling operations performed by the normalisation and scaling circuitry 120. In addition, there are a number of different rounding operations that may take place depending on the desires of the user performing the square root operation. Having performed any scaling and rounding operations, the end result is output by the scaling and rounding circuitry 170.

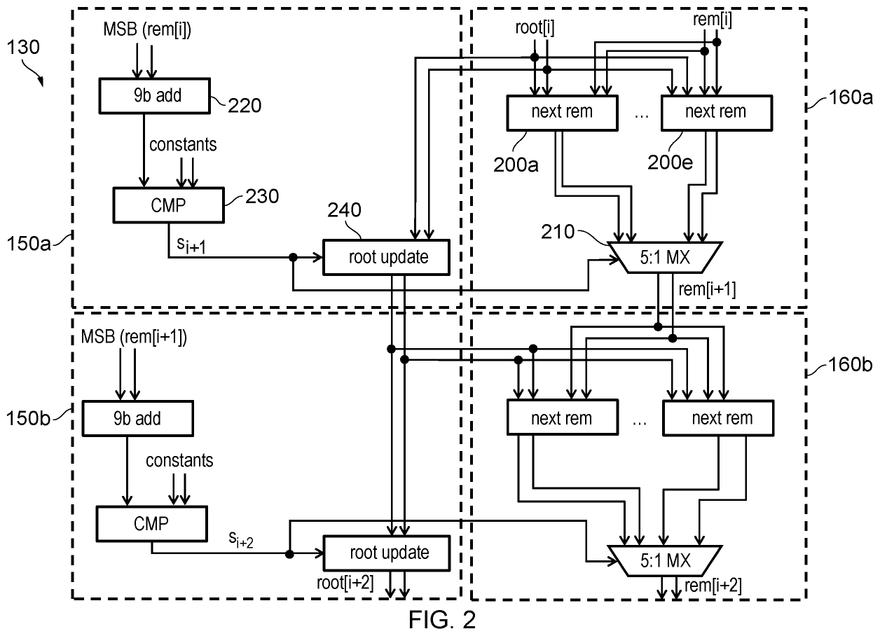

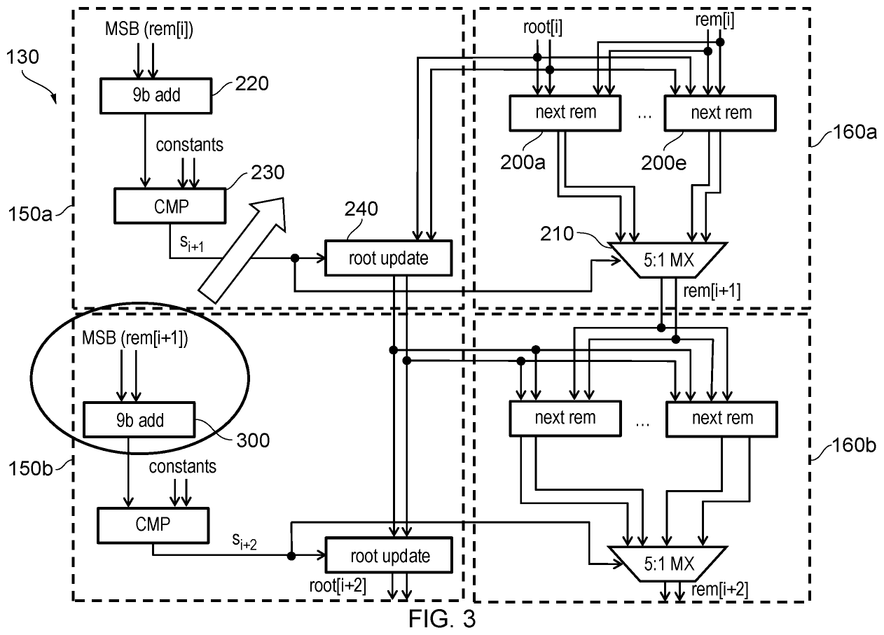

FIG. 2 illustrates an example of the processing circuitry 130 in accordance with some embodiments. In these embodiments, the digit determination circuitry 150 is made out of a first digit determination circuitry component 150a and a second digit determination circuitry component 150b. The first digit determination circuitry component 150a is responsible for producing a first digit from an iteration of the square root operation and the second digit determination circuitry component 150b is responsible for determining a second digit of the result from a further iteration of the square root operation. Similarly, the remainder determination circuitry 160 is made from a first remainder determination circuitry component 160a and a second remainder determination circuitry component 160b. In the same way as the digit determination circuitry, the first remainder determination circuitry component 160a is responsible for producing the remainder value of an iteration of the square root operation and the second remainder determination circuitry component 160b is responsible for producing a further remainder value from a further iteration of the square root operation.

The first remainder determination circuitry component 160a receives the at least partial root and the remainder value from the previous iteration in redundant representation. The at least partial root comprises all of the output digits that have been output by the digit determination circuitry 150 so far. This at least partial root is at least partial because the concatenation of all of the digits could be an exact square root, but also might not be. The at least partial root and the remainder value are received by the next remainder determination circuitry 200a. This calculates the remainder of the current iteration according to the equation:

rem[i+1]=r×rem[i]−sᵢ₊₁×(2×S[i]+sᵢ₊₁×r⁻⁽ⁱ⁺¹⁾)

where ‘i’ is the iteration number, ‘r’ is the radix (e.g. 4), ‘sᵢ’ is the digit output in iteration i, ‘a’ is the largest output digit by radix r, and ‘Sᵢ’ is the partial root before iteration i.

Note that there are five next remainder circuitries 200a, 200b, 200c, 200d, 200e. Each of the five next remainder circuits 200a, 200b, 200c, 200d, 200e speculatively determines the next remainder value each assuming a different value for the newly determined digit that will be output by the first digit determination circuitry component 150a. Accordingly, these circuits produce a set of candidate remainder values, each of which are input to a 5:1 multiplexer 210. In this way, five different candidate values for the next remainder value rem [i+1] are produced by each of the next remainder circuits 200. Once the digit for the current iteration sᵢ₊₁ is determined, this is used as a selection signal for the 5:1 multiplexer 210 to select the correct one of the five candidates to be output as the remainder value for the current iteration rem[i+1]. Consequently, there is no need to wait for the digit for the current iteration to be known before performing the calculation for the remainder value of the current iteration. This can significantly reduce the length of the “critical path”.

The first digit determination circuitry component 150a operates substantially simultaneously to the first remainder determination circuitry component 160a. The first digit determination circuitry component 150a takes as an input, the most significant bits of the remainder value of the previous iteration rem[i] (in redundant representation). In this embodiment, the square root operation is assumed to be operating in radix-4 and therefore the appropriate level of accuracy that is necessary is 9-bits. Accordingly, a 9-bit adder 220 is provided to convert the most significant bits of the remainder of the previous iteration from redundant representation to non-redundant representation. The output of the adder 220 is then provided to comparison circuitry 230. Here, the most significant bits of the remainder value are compared to different comparison constants in order to determine the output digit for the current iteration sᵢ₊₁. Such selection constants are provided in the literature, such as in “Division and Square Root: Digit Recurrent Algorithms and Implementations”, Section 8.2.1, by Miloš D. Ercegovac and Tomás Lang, 1994 edition, published by Kluwer Academic Publishing.

The digit is then provided to both root update circuitry 230, which updates the at least partial root, and to the 5:1 multiplexer 210 in the first remainder determination circuitry component 160a as a selection signal as previously discussed.

In this embodiment, the second digit determination circuitry component 150b operates in a similar manner to that of the first digit determination circuitry component 150a. The significant difference here is that the outputs of the second digit determination circuitry 150b and the second remainder determination circuitry 160b can either be provided back as inputs to the first digit determination circuitry 150a and the first remainder determination circuitry 160a if a further iteration is to be carried out, or can be output as the final result if further iterations are not to be performed.

Accordingly, it can be seen that by the provision of the next remainder circuits 200, it is possible to speculatively determine the next remainder value at each iteration before at least one of the inputs required for that calculation is known. In particular, a number of next remainder circuits 200 is provided such that the calculation of the next remainder can be performed in parallel, with each circuit 200a, 200b, 200c, 200d, 200e assuming a different one of the possible values for the current digit sᵢ₊₁. Once the actual value of the current digit sᵢ₊₁ is known, this can be used as a selection signal to the 5:1 multiplexer 210 to select the corresponding remainder value. Accordingly, rather than having to perform this calculation after the current digit sᵢ₊₁ is known, the calculation can be performed ahead of time (e.g. in parallel with the digit determination circuitry 150) and having determined the next digit sᵢ₊₁, a mere selection operation need be performed in order to output the corresponding remainder value. As a consequence, the remainder value can be output quickly once the next digit is known and so the operation completes quickly. Consequently, the timing constraints for each iteration of the square root operation are reduced. This can, in some cases, allow for a larger number of iterations of the square root operation to be performed in a single cycle of a processor. This in turn causes the square root operation to be performed more quickly. The skilled person will therefore appreciate that due to the placement particular components within the processing circuitry 130 it is possible for particular operations to be parallelised and/or performed speculatively by the circuitry in order for the circuitry to operate more quickly.

25

FIG. 3 illustrates a way in which a similar technique may be used instead of or as well as the technique illustrated with respect of FIG. 2. In particular, the 9-bit adder 300 of the second digit determination circuitry 150b need not necessary take place as part of the second digit determination circuitry 150b. In particular, these embodiments realise that the possible inputs to the 9-bit adder 300 are also limited and therefore outputs for the 9-bit adder 300 can be speculatively produced. This operation can be performed in the first digit determination circuitry 150a at a similar time to the operation of the 9-bit adder 220 and the comparison circuitry 230 of the first digit determination circuitry 150a. In a similar manner to that described in relation to FIG. 2, by speculatively performing this calculation and then selecting the correct output once the next digit sᵢ₊₁ is known, the critical path can be reduced by only requiring a selection operation to take place once the next digit sᵢ₊₁ is known rather than an addition operation. An example of how such circuitry may be configured is illustrated with respect of FIG. 4.

FIG. 4 illustrates an example of processing circuitry 130′ in which the 9-bit adder 300 circuitry has been moved to the first digit determination circuitry 150a′. As with the previously described techniques, the 9-bit adder circuitry is provided five times 300a, 300b, 300c, 300d, 300e in order to speculatively produce a value of the remainder for the current iteration rem[i+1] in non-redundant representation. This is produced as a consequence of providing, in this example, five 9-bit adders 300a-300e which are each responsible for producing a candidate value of the remainder value of the current iteration rem[i+1]. Each adder 300a-300e acts as if the next digit to be output by the comparison circuitry 230 is a different one of possible values −2, −1, 0, 1, 2 (for radix-4). The existence of five possible values necessities five 9-bit adders. These candidates are provided to a 5:1 multiplexer 400. The selection signal to the 5:1 multiplexer 400 is the output digit for the current iteration sᵢ₊₁. Consequently, when the next digit is known, this can be provided to the multiplexer in order to provide the appropriate remainder value for the current iteration in non-redundant representation. As a consequence of this, there is no need for the 9-bit adder circuitry 300 to operate after the digit has been determined. In other words, this circuitry has been removed from the critical path and can operate substantially in parallel with the 9-bit adder 220 that is already located in the first digit determination circuitry 150a′. As a consequence, the amount of processing that exists on the critical path for the digit determination circuitry 150 in total can be reduced. Again, this results in the square-root operation being performed more quickly and can lead to timing constraints being met more easily.

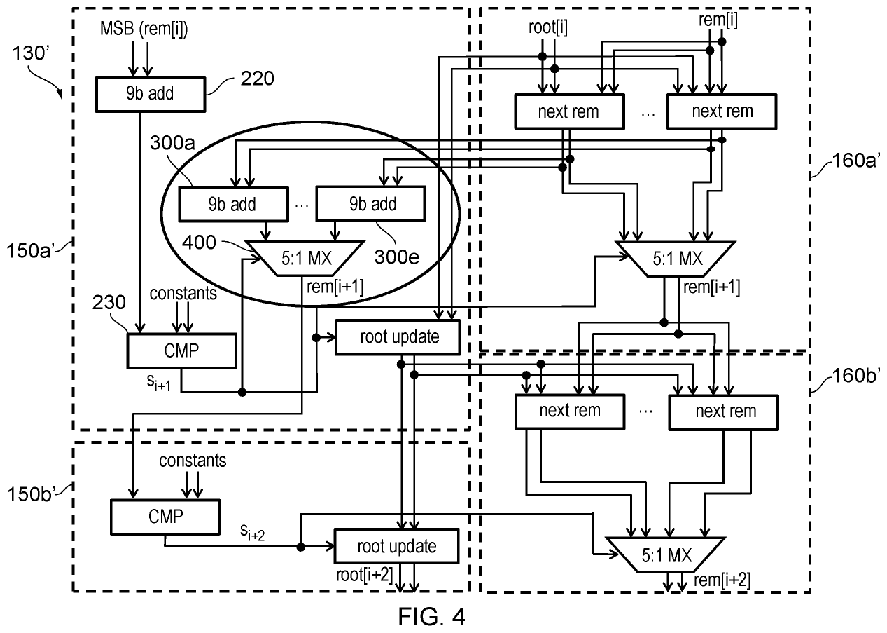

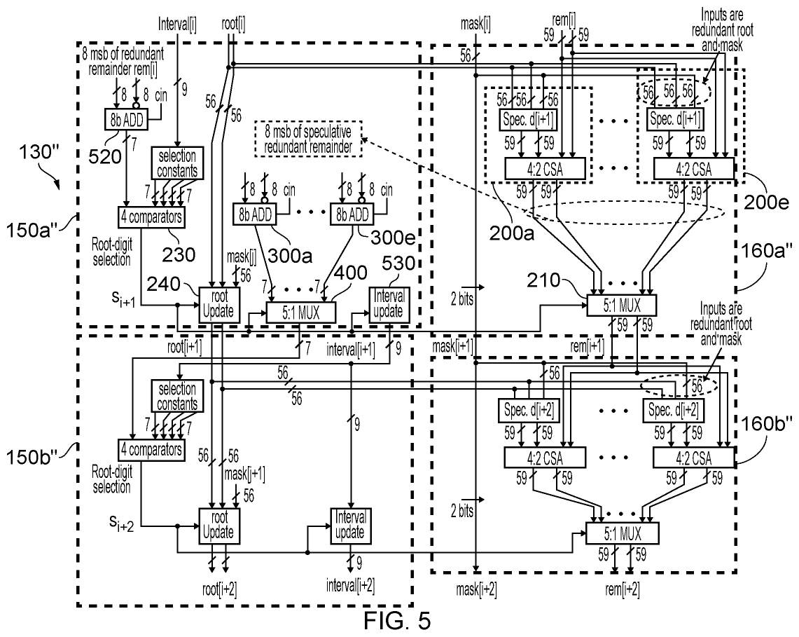

FIG. 5 illustrates an embodiment of the processing circuitry 130″ in more detail. Of particular note is that the 9-bit adder circuitry 220 has been replaced with an 8-bit adder 520. This adder is able to perform an effective addition to 9-bits by additionally using a carry in signal cin. Also in this embodiment, the select constants that are provided to the comparison circuitry 230 are generated as a consequence of an interval[i]. The intervals change for the first two iterations (because the first two digits of the partial root determine the interval) and separate the possible range for the partial root at iteration i root[i] into a number of equal sized segments.

The interval value is updated in the first digit determination circuitry component 150a″ by interval update circuitry 530. In relation to the next remainder circuitry 200, a mask is used in order to concatenate the most recently determined digit (made up from two bits, due to this implementation being radix-4) at the correct position of the shifted partial root and this input is provided to a 4:2 carry save adder together with the remainder value from the previous iteration rem [i]. Note that the mask value is right shifted by two bits between the first remainder determination circuitry component 160a″ and the second remainder determination circuitry component 160b″. This is due to the concatenation to a further digit (comprising two bits) between the two components 160a″ and 160b″. It will be noted that many of the inputs for the partial-root are 56 bits. This is because in a double precision floating-point number, there are 53 fractional bits. A guard bit is required for the rounding operation. Adding bits for the integer component, plus padding bring the total to 56 bits. 59 bits are provided for the remainder input. These include 55 fractional bits and four integer bits (due to the maximum value of the remainder).

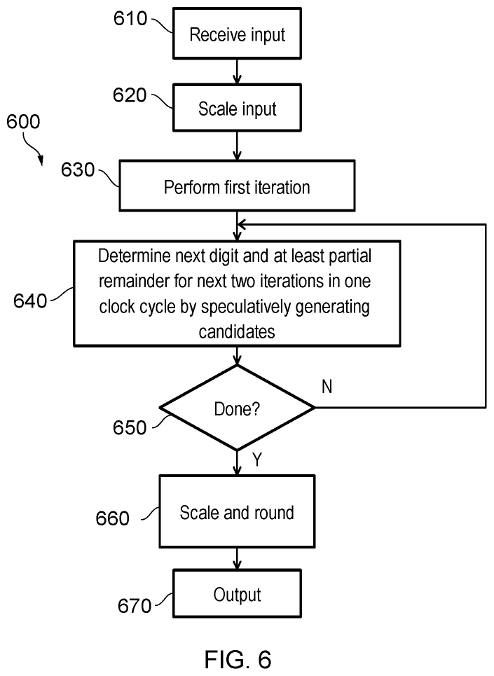

FIG. 6 illustrates a flow chart 600 that shows a method of data processing in accordance with one embodiment. At a step 610 an input is received that indicates a value that is to be the subject of the square root operation. At a step 620 the input value is scaled and converted to a normalised format as appropriate. At a step 630 a first iteration of the square root operation is performed. The first operation may be considered separately from other iterations because it may be possible to perform the first iteration quicker than other iterations due to a limited number of possible input values. In any event, at step 640 the next digit and the at least partial remainder value are determined for the next two iterations in a single clock cycle. This process involves the speculative generation of a set of candidate at least partial remainders of the square root operation for at least one of these iterations prior to the at least partial result of the square root operation of the current iteration being determined. At step 650, it is determined whether the operation is complete. This may be determined based on the number of iterations that have been performed and whether a desired level of accuracy has been achieved with those iterations. If further iterations are to be performed (e.g. the process is not complete) then the process returns to step 640 where a further two iterations are performed. Otherwise, at step 660, the output digits from steps 630 and 640 are concatenated in order to produce the result. This is then scaled and rounded as appropriate and the final value is output at step 670. Note that in some embodiments, at step 640 it may be possible to indicate that only one further iteration is to be performed rather than two—e.g. if this would bring the level of precision to the desired level.

Accordingly, it has been demonstrated that by speculatively producing a set of candidate values prior to the at least partial result of a current iteration being determined, it is possible for the number of operations on the critical path to be reduced. As a consequence, some of the processing can be parallelised and consequently the amount of time required for each iteration to complete can be increased. This in turn makes it possible for timing constraints to be loosened or more iterations to be performed in a single clock cycle than may otherwise be possible. It is therefore possible for the square root operation to be performed more quickly.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising:
input circuitry to receive a signal corresponding to a square root instruction that identifies an input value;
processing circuitry to perform an iterative square root operation on the input value, the processing circuitry comprising:
digit determination circuitry to determine, for a current iteration, a next digit of an at least partial result of the square root operation; and
remainder determination circuitry to determine, for the current iteration,
an at least partial remainder of the square root operation, wherein
the next digit for the current iteration is determined based on an at least partial remainder of the square root operation from a previous iteration;
the at least partial remainder for the current iteration is determined based on the at least partial remainder and the at least partial result of the square root operation from the previous iteration; and
the processing circuitry is adapted to speculatively generate a set of candidate at least partial remainders of the square root operation for the current iteration prior to the at least partial result of the square root operation for the current iteration being determined.

2. The data processing apparatus according to claim 1, wherein
each of the candidate at least partial remainders of the square root operation for the current iteration is in redundant representation.

3. The data processing apparatus according to claim 1, wherein
the processing circuitry is adapted to speculatively generate the set of candidate at least partial remainders of the square root operation for the current iteration prior to the next digit being determined by the digit determination circuitry.

4. The data processing apparatus according to claim 1, wherein
the set of candidate at least partial remainders comprises one candidate value for each possible value of a most recent digit of the at least partial remainder.

5. The data processing apparatus according to claim 1, comprising:
normalisation circuitry to normalise the input value.

6. The data processing apparatus according to claim 1, wherein
the processing circuitry is adapted to perform two iterations in a single clock cycle.

7. The data processing apparatus according to claim 1, wherein
the iterative square root operation is radix-4.

8. The data processing apparatus according to claim 1, wherein
the at least partial remainder of the square root operation from the previous iteration comprises a predetermined number of most significant bits of an at least partial remainder of the square root operation from the previous iteration.

9. The data processing apparatus according to claim 1, wherein
at least one of the at least partial remainder of the square root operation from the previous iteration and the at least partial result of the square root operation from the previous iteration is provided in redundant representation.

10. The data processing apparatus according to claim 1, wherein
the processing circuitry is adapted to speculatively generate the set of candidate at least partial remainders of the square root operation for the current iteration in both redundant and non-redundant representation; and
the candidate at least partial remainders of the square root operation for the current iteration that are in non-redundant representation are based on most significant bits of the at least partial remainder of the square root operation from the previous iteration.

11. A data processing method comprising:
receiving a signal corresponding to a square root instruction that identifies an input value;
performing an iterative square root operation on the input value by:
determining, for a current iteration, a next digit of an at least partial result of the square root operation;
determining, for the current iteration, an at least partial remainder of the square root operation, wherein
the next digit for the current iteration is determined based on an at least partial remainder of the square root operation from a previous iteration;
the at least partial remainder for the current iteration is determined based on the at least partial remainder and the at least partial result of the square root operation from the previous iteration; and
a set of candidate at least partial remainders of the square root operation are speculatively generated for the current iteration prior to the next digit being determined.

12. (canceled)
